(19) United States
(12) Patent Application Publication
(10) Pub. No.: US 2023/0385858 A1
(43) Pub. Date: Nov. 30, 2023

(54) METHODS AND APPARATUS TO ADJUST FOR NON-RESPONSE USING BIG DATA

(71) Applicant: The Nielsen Company (US), LLC, New York, NY (US)

(72) Inventors: David J. Kurzynski, South Elgin, IL (US); Bill Harvey, Gardiner, NY (US)

(21) Appl. No.: 17/949,812

(22) Filed: Sep. 21, 2022

Related U.S. Application Data
(60) Provisional application No. 63/347,386, filed on May 31, 2022.

(51) Int. Cl. G06Q 30/02

(52) U.S. Cl. CPC G06Q 30/0203

(57) ABSTRACT

Methods, apparatus, systems, and articles of manufacture are disclosed to analyze nonresponse-related gaps in panel data, by using big data. An apparatus to adjust panelist data comprising at least one memory, machine readable instructions, and processor circuitry to at least one of instantiate or execute the machine readable instructions to communicate with an external data source to obtain external data, the external data including information on a potential panelist, identify the potential panelist from the panelist data, generate weighting information on the potential panelist based on the panelist data using a weighting model, calculate a correction factor based on the weighting information, and apply the correction factor to update the panelist data.

### RELATED APPLICATIONS

This patent claims the benefit of U.S. Provisional Patent Application No. 63/347,386, which was filed on May 31, 2022. U.S. Provisional Patent Application No. 63/347,386 is hereby incorporated herein by reference in its entirety. Priority to U.S. Provisional Patent Application No. 63/347,386 is hereby claimed.

### FIELD OF THE DISCLOSURE

This disclosure relates generally to media audience monitoring and, more particularly, to methods and apparatus to adjust for non-response using big data.

### BACKGROUND

Traditionally, audience measurement entities (also referred to herein as “ratings entities”) determine demographic reach for advertising and media programming based on registered panel members. That is, an audience measurement entity enrolls people that consent to being monitored into a panel. During enrollment, the audience measurement entity receives demographic information from the enrolling people so that subsequent correlations may be made between advertisement/media exposure to those panelists and different demographic markets.

People become panelists via, for example, a user interface presented on the media device (e.g., via a website). People become panelists in additional or alternative manners such as, for example, via a telephone interview, by completing an online survey, etc. Additionally or alternatively, people may be contacted and/or enlisted using any desired methodology (e.g., random selection, statistical selection, mail solicitations and household visits, phone solicitations, Internet advertisements, surveys, advertisements in shopping malls, product packaging, etc.).

### BRIEF DESCRIPTION OF THE DRAWINGS

FIG. 1 is a block diagram of an example media measurement system.

FIG. 2 is a block diagram of the example server of FIG. 1.

FIG. 3 is a flowchart representative of example machine readable instructions and/or example operations that may be executed by example processor circuitry to implement the server of FIG. 2.

FIG. 4 is a flowchart representative of example machine readable instructions and/or example operations that may be executed by example processor circuitry to implement the weighting generator circuitry of FIG. 2.

FIG. 5 is a block diagram of an example processing platform including processor circuitry structured to execute the example machine readable instructions and/or the example operations of FIGS. 3 and/or 4 to implement the audience measurement data correcting server of FIG. 2.

FIG. 6 is a block diagram of an example implementation of the processor circuitry of FIG. 5.

FIG. 7 is a block diagram of another example implementation of the processor circuitry of FIG. 5.

In general, the same reference numbers will be used throughout the drawing(s) and accompanying written description to refer to the same or like parts. The figures are not to scale.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

Audience measurement entities determine demographic reach for advertising and media programming based on registered panel members. Probability samples are an important part of implementing panels of such panel members. However, all these samples (whether probability type or not) may be deficient because of the tendency for data obtained from people (e.g., panelists) to be different in relevant ways from people whose data has not been obtained (e.g., non-panelists).

In all samples, there are three types of errors. First is random (statistical) error. This type of the error is the error introduced by using any sample. The second and third types of errors are response bias and non-response bias. Between these two errors, in the context of modern passive metering rather than questionnaire collected information, non-response error is the one likely to cause the more bias and is therefore the primary focus of this disclosure.

An audience measurement entity maintains records of the names and addresses of the people that were in an original predesignated sample of potential panelists. Non-panelists are representative of non-contacts (e.g., persons who did not respond to a request to join a panel), and refusers (e.g., persons who responded to a request to join a panel, and indicated their preference to not join the panel). The non-contacts and refusers represent ones that never made it onto the panel. Additionally, many third-party companies store data about their customers. The audience measurement entity can utilize the data from the third-party companies to match the list of non-contacts and refusers to generate a response for the non-contacts and refusers. The data obtained for the non-contacts and refusers can then be compared to the household ratings of a national panel and local panels of the audience measurement entity as sample size allows. Any differences between non-contacts/refusers and the respective panel, within the same demographic or other type (geographic, psychographic, media technology ownership, and so on), can be mitigated by adjustment factors, and this can become part of the production system. As a result, the non-response error will be reduced.

While example approaches disclosed herein are explained in the context of requesting users to join a panel for media audience measurement purposes, it should be understood that such approaches may additionally or alternatively be used for other scenarios where persons might be non-responsive or refuse to answer a survey. For example, any type of marketing research may benefit from the teachings of this disclosure. Moreover, different types of information collection approaches could be used instead of panels including, for example, surveys, questionnaires, audits, etc.

As used herein, the term “media” includes any type of content and/or advertisement delivered via any type of distribution medium. Thus, media includes television programming or advertisements, radio programming or advertisements, movies, web sites, streaming media, etc. Example methods, apparatus, and articles of manufacture disclosed herein monitor media presentations at media devices. Such media devices may include, for example, Internet-enabled televisions, personal computers, Internet-enabled mobile handsets (e.g., a smartphone), video game consoles (e.g., Xbox®, PlayStation®), tablet computers (e.g., an iPad®), digital media players (e.g., a Roku® media player, a Slingbox®, etc.), etc. In some examples, media monitoring information is aggregated to determine ownership and/or usage statistics of media devices, relative rankings of usage and/or ownership of media devices, types of uses of media devices (e.g., whether a device is used for browsing the Internet, streaming media from the Internet, etc.), and/or other types of media device information. In examples disclosed herein, monitoring information includes, but is not limited to, media identifying information (e.g., media-identifying metadata, codes, signatures, watermarks, and/or other information that may be used to identify presented media), application usage information (e.g., an identifier of an application, a time and/or duration of use of the application, a rating of the application, etc.), and/or user-identifying information (e.g., demographic information, a user identifier, a panelist identifier, a username, etc.).

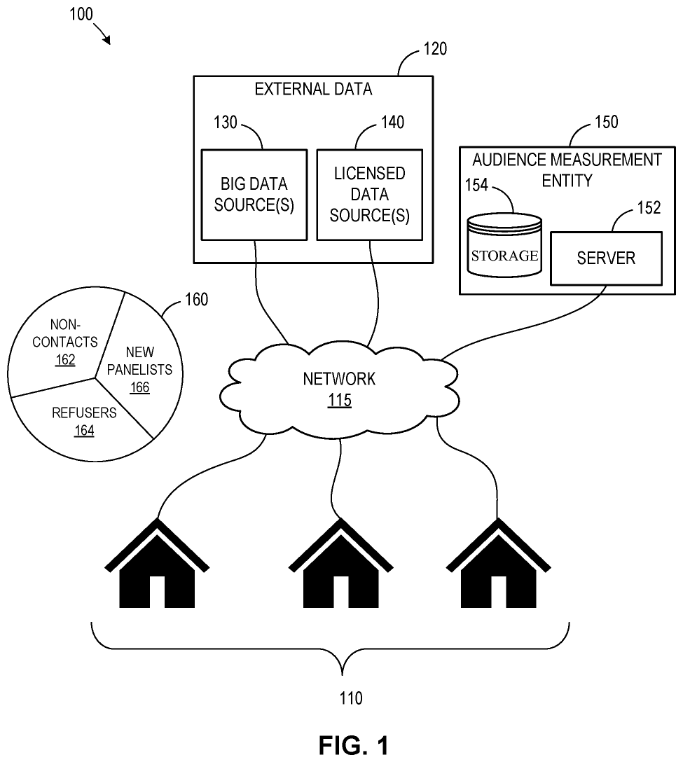

FIG. 1 is a block diagram of an example media measurement system 100. The example media measurement system 100 includes households 110, a network 115, an audience measurement entity 150, and external data 120.

The example households 110 include households that have been included as panelists and potential panelists for media audience monitoring. These households can be from virtually any demographic type and can even be separated by demographic types. The example households 110 may be distinguished by a variety of other factors that may be desirable for media audience monitoring. For example, the example households 110 may be separated or distinguished by age, such as for example, using panelists that are only in a specific age range (e.g., people born during a specific period of time). The example households 110 may be distinguished by the number of people in a single household. It should be known that the example households 110 are not limited to the examples described above. Any person or group of persons from any household may be a panelist and be included in the sample of example households 110.

The example households 110 or persons therein, after agreeing to be panelists, are representative of a media audience monitored through any currently known technique or any newly discovered technique. For example, a panelist may be monitored by a television set tuning meter, where the meter closely monitors a variety of factors, including but not limited to, television usage, media presented by the television, types of channels viewed, duration of which the channels are tuned, etc. Additionally or alternatively, a panelist may be monitored by a people meter, which measures not only set tuning but also which household members or visitors are present and viewing that content. The monitoring is not limited to televisions but can be any media distribution medium (e.g., streaming media, video on demand, etc.).

The example network 115 receives information from the example households 110 and external data 120. The network 115 facilitates communication between the example households 110, the external data 120, and the audience measurement entity 150. The information communicated via the network 115 is then stored and utilized to provide desired information. The network 115 may also serve to facilitate questionnaires to potential panelists, such as for example, by an online questionnaire.

The example audience measurement entity 150 represents a monitoring company that desires knowledge on how users interact with media devices such as smartphones, tablets, laptops, smart televisions, etc., and their media monitoring habits and/or exposures on those media devices. In some examples, audience measurement entity 150 may desire monitoring media presentations made at the media devices to, among other things, monitor exposure to advertisements, determine advertisement effectiveness, determine user behavior, identify purchasing behavior associated with various demographics, etc.

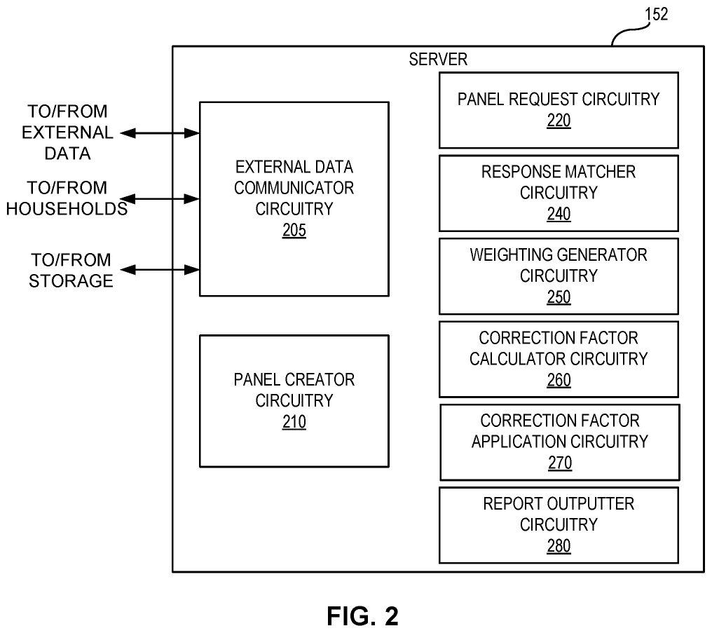

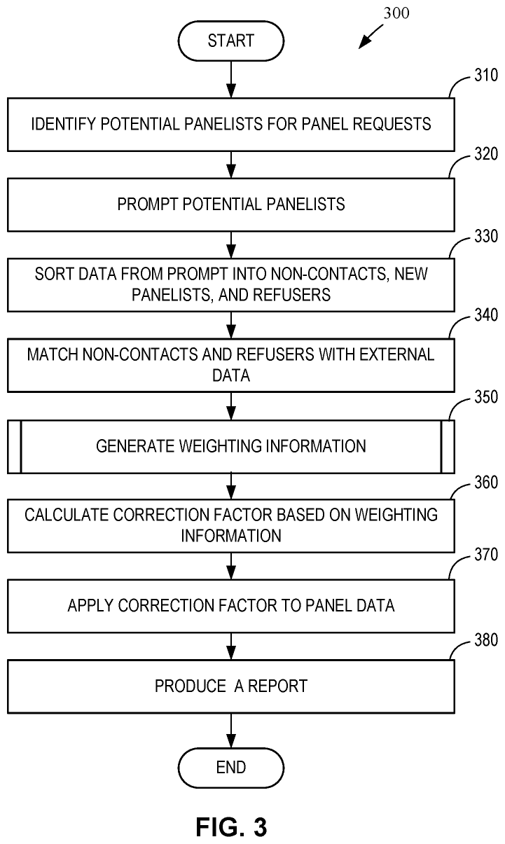

In some examples, the audience measurement entity 150 includes a server 152 and an example storage 154. The server 152 is utilized to correct data so as to provide accurate panelist data and is further discussed in reference to FIGS. 2, 3, and/or 4 below. The example storage 154 may be used to store panelist data that can be accessed by the server 152.

The external data 120 shown in FIG. 1 may include one or more big data source(s) 130 and/or licensed data source(s) 140. The big data source(s) 130 may include any census level data that consists of summary and/or granular statistics that describe geographic areas and/or monitoring information (e.g., media monitoring information). This information may include but is not limited to population estimates and/or demographic components of change (e.g., births, deaths, migration). The big data source(s) 130 may further provide information relating to characteristics such as age, sex, race, etc. The licensed data source(s) 140 may include any number of licensed data source(s) to which the audience measurement entity 150 has access. For example, licensed data may be tuning data by date and time and may cover streaming service data, television network data, media service provider data, smart television manufacturer data, etc. It should be known that as more licenses are obtained, the newly obtained information can be incorporated into the approaches disclosed herein.

A responder category chart 160 is shown in FIG. 1 provides a graphical representation of the categories in which the potential panelist may fall as a result of a request to join a panel. As shown in the responder category chart 160, the potential panelists and their subsequent responses (or non-responses), are represented as: non-contacts 162, refusers 164, and new panelists 166. The non-contacts 162 represent potential panelists who were sent a panel invitation request, but for whatever reason, did not respond. Such non-response may be the result of the potential panelist refusing to join the panel, may be the result of the potential panelist ignoring the request to join the panel, or even may be the result of the potential panelist never receiving the request (e.g., as a result of incorrect contact information). In some examples, the non-contacts 162 may also represent potential panelists that did not receive an invitation after numerous (e.g., at least six) requests to join. The refusers 164 represent potential panelists that, although receiving the request to join the panel, have decided to refuse the request and provide an indication of their refusal. The new panelists 166 represent people who have agreed to join as members of the panel. Obtaining information from all potential panelists is important because every non-contact 162 and/or refuser 164 introduces bias into the panelist data which may provide an inaccurate representation of a population.

Additionally, panelists provide important information that serves an important role in the entertainment field. For example, the panelist data allows the audience measurement entity 150 to obtain insight into consumer behavior. This information may include, but is not limited to, the audiences for television and radio shows, newspaper articles, streaming services, etc. This information can provide entertainment suppliers and a variety of other industries involved within the entertainment field, such as a company's marketing team, information necessary to shape business strategies in order to increase profits and/or viewership. It should be known, however, that the information gleaned from the questionnaires may serve a unique purpose for each receiver of such information. As an example, a retail company looking to increase its consumer store traffic and profits may use this information primarily to target their advertisements towards specific television networks, streaming services, and/or newspapers. Alternatively, in some examples, an entertainment company, such as a television production network, may use this data to obtain viewership reports on specific content to determine the success of the content. Accordingly, any bias (e.g., response and non-response bias) can lead to less accurate results, thus making business strategies harder to shape.

FIG. 2 is a block diagram of the example server 152 of FIG. 1 to obtain panelist data otherwise unattainable about the non-contacts 162 and refusers 164. The example server 152 of FIG. 2 may be instantiated (e.g., creating an instance of, bring into being for any length of time, materialize, implement, etc.) by processor circuitry such as a central processing unit executing instructions. Additionally, or alternatively, the example server 152 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers.

The example server 152 includes external data communicator circuitry 205, panel creator circuitry 210, panel request circuitry 220, response matcher circuitry 240, weighting generator circuitry 250, correction factor calculator circuitry 260, correction factor application circuitry 270, and report outputter circuitry 280.

The external data communicator circuitry 205 communicates with the external data 120 via network 115. In some examples, the external data communicator 205 communicates with the example storage 154. In other examples, the data communicator circuitry 205 communicates with the households 110 via network 115. In some examples, the external data communicator circuitry 205 is instantiated by processor circuitry executing the external data communicator instructions and/or configured to perform operations such as those represented by the flowchart of FIG. 3.

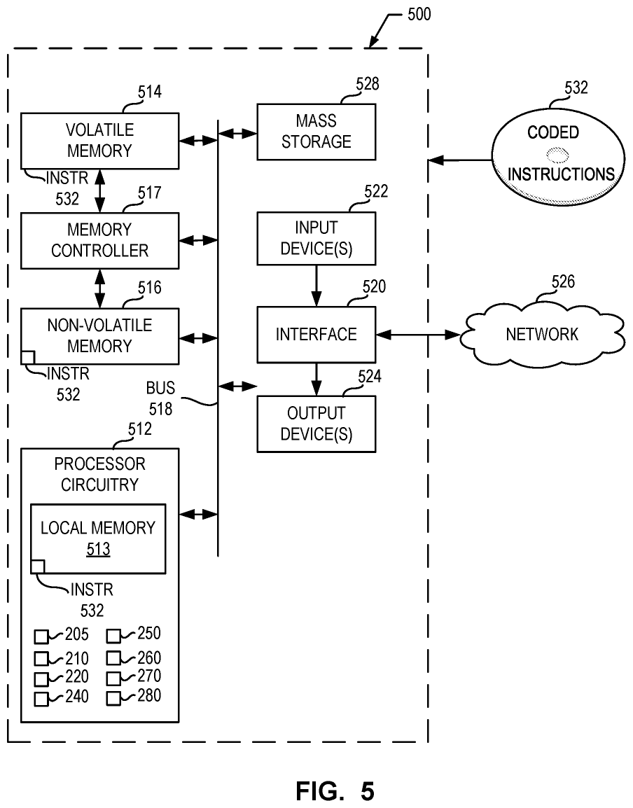

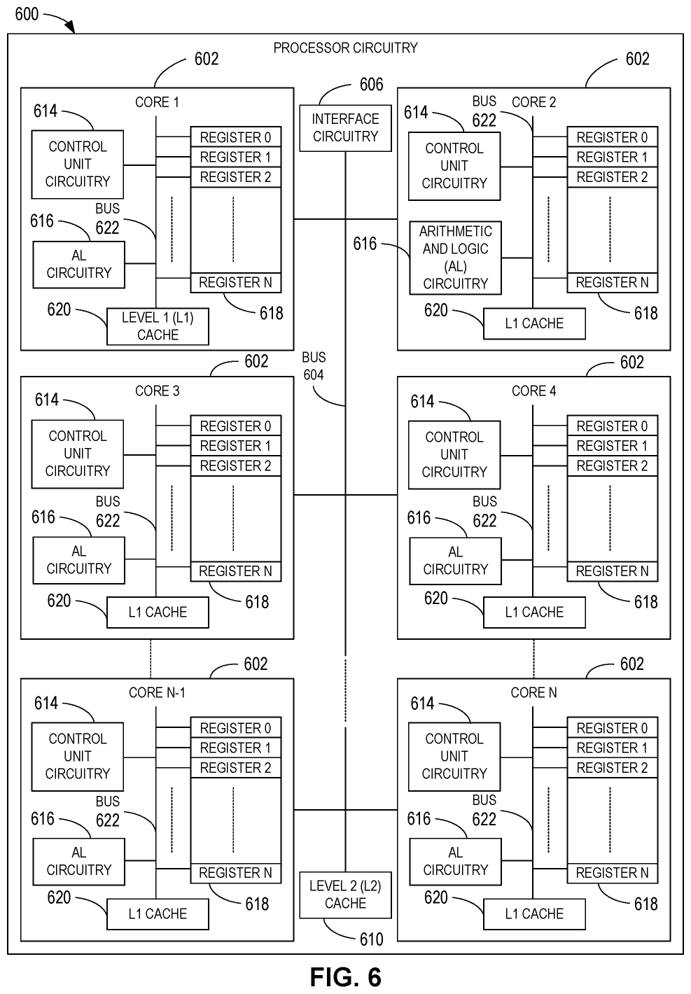

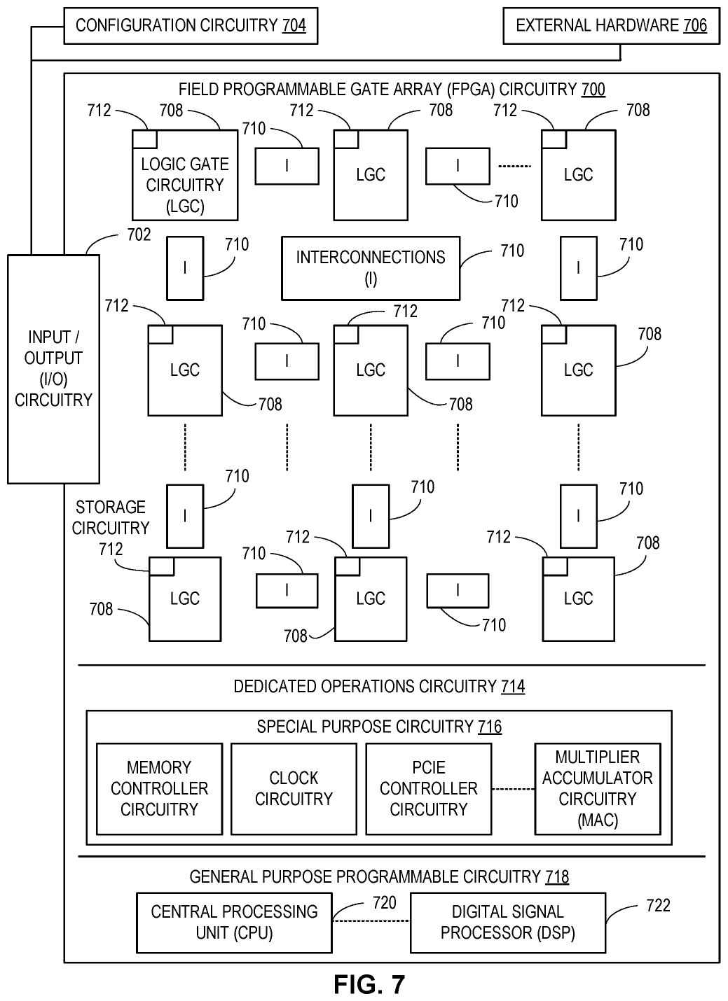

In some examples, the server 152 includes means for communicating with external data via the network 115. For example, the means for communicating may be implemented by the example external data communicator circuitry 205. In some examples, the external data communicator circuitry 205 may be instantiated by processor circuitry such as the example processor circuitry 512 of FIG. 5. For instance, the external data communicator circuitry 205 may be instantiated by the example microprocessor 600 of FIG. 6 executing machine executable instructions such as those implemented by at least block 340 of FIG. 3. In some examples, the external data communicator circuitry 205 may be instantiated by hardware logic circuitry, which may be implemented by an ASIC, XPU, or the FPGA circuitry 700 of FIG. 7 structured to perform operations corresponding to the machine readable instructions. Additionally or alternatively, the external data communicator circuitry 205 may be instantiated by any other combination of hardware, software, and/or firmware. For example, the external data communicator circuitry 205 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example panel creator circuitry 210 identifies potential panelists for panel recruitment and sorts the potential panelists into non-contacts 162, refusers 164, and new panelists 166. In some examples, the panel creator circuitry 210 identifies potential panelists by accessing the data provided by the external data 210. In some examples, the panel creator circuitry 210 identifies potential panelists by accessing the data stored within the example storage 154. In other examples, the panel creator circuitry 210 identifies potential panelists by communicating with the households 110 directly. In some examples, the panel creator circuitry 210 is instantiated by processor circuitry executing panel creator instructions and/or configured to perform operations such as those represented by the flowchart of FIG. 3.

In some examples, the server 152 includes means for identifying potential panelists. For example, the means for identifying may be implemented by the example panel creator circuitry 210. In some examples, the panel creator circuitry 210 may be instantiated by processor circuitry such as the example processor circuitry 512 of FIG. 5. For instance, the panel creator circuitry 210 may be instantiated by the example microprocessor 600 of FIG. 6 executing machine executable instructions such as those implemented by at least block 310 of FIG. 3. In some examples, the panel creator circuitry 210 may be instantiated by hardware logic circuitry, which may be implemented by an ASIC, XPU, or the FPGA circuitry 700 of FIG. 7 structured to perform operations corresponding to the machine readable instructions. Additionally or alternatively, the panel creator circuitry 210 may be instantiated by any other combination of hardware, software, and/or firmware. For example, the panel creator circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the means for identifying potential panelists includes means for accessing data. For examples, the means for accessing may be implemented by the example external data communicator circuitry 205. In some examples the external data communicator circuitry 210 may be instantiated by processor circuitry such as the example processor circuitry 512 of FIG. 5. For instance, the external data communicator circuitry 205 may be instantiated by the example microprocessor 600 of FIG. 6 executing machine executable instructions such as those implemented by at least block 310 of FIG. 3. In some examples, the external data communicator circuitry 205 may be instantiated by hardware logic circuitry, which may be implemented by an ASIC, XPU, or the FPGA circuitry 700 of FIG. 7 structured to perform operations corresponding to the machine readable instructions. Additionally or alternatively, the external data communicator circuitry 205 may be instantiated by any other combination of hardware, software, and/or firmware. For example, the external data communicator circuitry 205 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the means for identifying potential panelists includes means for sorting the potential panelists. For example, the means for sorting may be implemented by the example panel creator circuitry 210. In some examples, the panel creator circuitry 210 may be instantiated by processor circuitry such as the example processor circuitry 512 of FIG. 5. For instance, the panel creator circuitry 210 may be instantiated by the example microprocessor 600 of FIG. 6 executing machine executable instructions such as those implemented by at least block 330 of FIG. 3. In some examples, the panel creator circuitry 210 may be instantiated by hardware logic circuitry, which may be implemented by an ASIC, XPU, or the FPGA circuitry 700 of FIG. 7 structured to perform operations corresponding to the machine readable instructions. Additionally or alternatively, the panel creator circuitry 210 may be instantiated by any other combination of hardware, software, and/or firmware. For example, the panel creator circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example panel request circuitry 220 obtains information from the panel creator circuitry 210 identifying the potential panelists. The panel request circuitry 220 then sends out a panel questionnaire to the potential panelists to request entry into a panel. In some examples, the panel request circuitry 220 is instantiated by processor circuitry executing panel requester instructions and/or configured to perform operations such as those represented by the flowchart of FIG. 3.

In some examples, the server 152 includes means for requesting entry into a panel. For example, the means for requesting may be implemented by the example panel request circuitry 220. In some examples, the panel request circuitry 220 may be instantiated by processor circuitry such as the example processor circuitry 512 of FIG. 5. For instance, the panel request circuitry 220 may be instantiated by the example microprocessor 600 of FIG. 6 executing machine executable instructions such as those implemented by at least block 320 of FIG. 3. In some examples, the panel request circuitry 220 may be instantiated by hardware logic circuitry, which may be implemented by an ASIC, XPU, or the FPGA circuitry 700 of FIG. 7 structured to perform operations corresponding to the machine readable instructions. Additionally or alternatively, the panel request circuitry 220 may be instantiated by any other combination of hardware, software, and/or firmware. For example, the panel request circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example response matcher circuitry 240 utilizes the external data 120 communicated through the external data communicator circuitry 205 to match non-contacts 162 and refusers 164 with the external data 120. In some examples, the response matcher circuitry 240 is instantiated by processor circuitry executing response matcher instructions and/or configured to perform operations such as those represented by the flowchart of FIG. 3.

In some examples, the server 152 includes means for matching non-contacts 162 and refusers 164 with external data. For example, the means for matching may be implemented by the example response matcher circuitry 240. In some examples, the response matcher circuitry 240 may be instantiated by processor circuitry such as the example processor circuitry 512 of FIG. 5. For instance, the response matcher circuitry 240 may be instantiated by the example microprocessor 600 of FIG. 6 executing machine executable instructions such as those implemented by at least block 340 of FIG. 3. In some examples, the response matcher circuitry 240 may be instantiated by hardware logic circuitry, which may be implemented by an ASIC, XPU, or the FPGA circuitry 700 of FIG. 7 structured to perform operations corresponding to the machine readable instructions. Additionally or alternatively, the response matcher circuitry 240 may be instantiated by any other combination of hardware, software, and/or firmware. For example, the response matcher circuitry 240 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example weighting generator circuitry 250 generates weighting information. In some examples, the weighting generator circuitry 250 updates a weighting model based on information learned from generating the weighting information. In some examples, the weighting generator circuitry 250 is instantiated by processor circuitry executing weighting generator instructions and/or configured to perform operations such as those represented by the flowcharts of FIGS. 3 and/or 4.

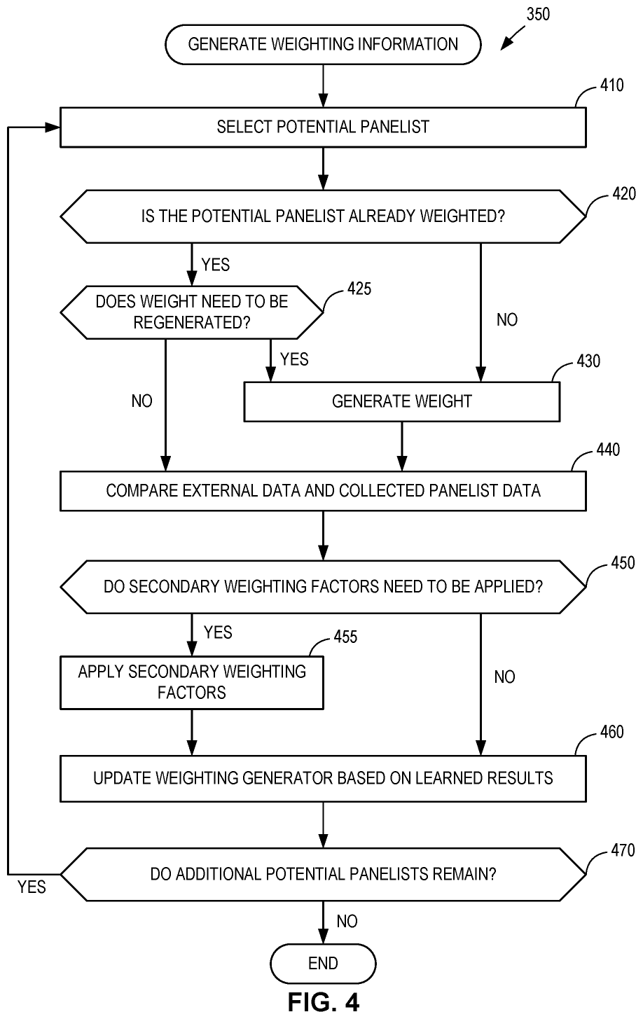

In some examples, the server 152 includes means for generating weighting information. For example, the means for generating may be implemented by the example weighting generator circuitry 250. In some examples, the weighting generator circuitry 250 may be instantiated by processor circuitry such as the example processor circuitry 512 of FIG. 5. For instance, the weighting generator circuitry 250 may be instantiated by the example microprocessor 600 of FIG. 6 executing machine executable instructions such as those implemented by at least blocks 350 of FIGS. 3 and 410, 420, 425, 430, 440, 450, 455 and 470 of FIG. 4. In some examples, the weighting generator circuitry 250 may be instantiated by hardware logic circuitry, which may be implemented by an ASIC, XPU, or the FPGA circuitry 700 of FIG. 7 structured to perform operations corresponding to the machine readable instructions. Additionally or alternatively, the weighting generator circuitry 250 may be instantiated by any other combination of hardware, software, and/or firmware. For example, the weighting generator circuitry 250 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the server 152 includes means for updating the weighting model. For example, the means for updating may be implemented by the example weighting generator circuitry 250. In some examples, the weighting generator circuitry 250 may be instantiated by processor circuitry such as the example processor circuitry 512 of FIG. 5. For instance, the weighting generator circuitry 250 may be instantiated by the example microprocessor 600 of FIG. 6 executing machine executable instructions such as those implemented by at least block 460 of FIG. 4. In some examples, the weighting generator circuitry 250 may be instantiated by hardware logic circuitry, which may be implemented by an ASIC, XPU, or the FPGA circuitry 700 of FIG. 7 structured to perform operations corresponding to the machine readable instructions. Additionally or alternatively, the weighting generator circuitry 250 may be instantiated by any other combination of hardware, software, and/or firmware. For example, the weighting generator circuitry 250 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example correction factor calculator circuitry 260 calculates a correction factor based on the weighting information. In some examples, the correction factor calculator circuitry 260 is instantiated by processor circuitry executing correction factor calculator instructions and/or configured to perform operations such as those represented by the flowchart of FIG. 3.

In some examples, the server 152 includes means for calculating a correction factor. For example, the means for calculating may be implemented by the example correction factor calculator circuitry 260. In some examples, the correction factor calculator circuitry 260 may be instantiated by processor circuitry such as the example processor circuitry 512 of FIG. 5. For instance, the correction factor calculator circuitry 260 may be instantiated by the example microprocessor 600 of FIG. 6 executing machine executable instructions such as those implemented by at least block 360 of FIG. 3. In some examples, the correction factor calculator circuitry 260 may be instantiated by hardware logic circuitry, which may be implemented by an ASIC, XPU, or the FPGA circuitry 700 of FIG. 7 structured to perform operations corresponding to the machine readable instructions. Additionally or alternatively, the correction factor calculator circuitry 260 may be instantiated by any other combination of hardware, software, and/or firmware. For example, the correction factor calculator circuitry 260 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example correction factor application circuitry 270 applies the correction factor calculated from the correction factor calculator circuitry 260 to the panel data. In some examples, the correction factor application circuitry 270 is instantiated by processor circuitry executing correction factor application instructions and/or configured to perform operations such as those represented by the flowchart of FIG. 3.

In some examples, the server 152 includes means for applying a correction factor. For example, the means for applying may be implemented by the example correction factor application circuitry 270. In some examples, the correction factor application circuitry 270 may be instantiated by processor circuitry such as the example processor circuitry 512 of FIG. 5. For instance, the correction factor application circuitry 270 may be instantiated by the example microprocessor 600 of FIG. 6 executing machine executable instructions such as those implemented by at least block 370 of FIG. 3. In some examples, the correction factor application circuitry 270 may be instantiated by hardware logic circuitry, which may be implemented by an ASIC, XPU, or the FPGA circuitry 700 of FIG. 7 structured to perform operations corresponding to the machine readable instructions. Additionally or alternatively, the correction factor application circuitry 270 may be instantiated by any other combination of hardware, software, and/or firmware. For example, the correction factor application circuitry 270 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example report outputter circuitry 280 produces a report of the panelist data with the correction factor applied. In some examples, the example report outputter circuitry 280 outputs the report for further use (such as analytics). In some examples, the report outputter circuitry 280 is instantiated by processor circuitry executing report outputter instructions and/or configured to perform operations such as those represented by the flowchart of FIG. 3. In examples disclosed herein, the report is provided to a client of the audience measurement entity 150. However, in some examples, the report may be made internally to the audience measurement entity 150 to, for example, enable improvement to future reports. In such an example, the report may be stored to the example storage 154.

In some examples, the server 152 includes means for producing a report of the potential panelist based on the updated panelist data. In some examples, the report is representative of potential panelists that have been sorted into the non-responder 162 or the refuser 164 categories. In some examples, the server 152 includes means for outputting the report. For example, the means for producing and the means for outputting may be implemented by the example report outputter circuitry 280. In some examples, the report outputter circuitry 280 may be instantiated by processor circuitry such as the example processor circuitry 512 of FIG. 5. For instance, the report outputter circuitry 280 may be instantiated by the example microprocessor 600 of FIG. 6 executing machine executable instructions such as those implemented by at least block 380 of FIG. 3. In some examples, the report outputter circuitry 280 may be instantiated by hardware logic circuitry, which may be implemented by an ASIC, XPU, or the FPGA circuitry 700 of FIG. 7 structured to perform operations corresponding to the machine readable instructions. Additionally or alternatively, the report outputter circuitry 280 may be instantiated by any other combination of hardware, software, and/or firmware. For example, the report outputter circuitry 280 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the server 152 of FIG. 1 is illustrated in FIG. 2, one or more of the elements, processes, and/or devices illustrated in FIG. 2 may be combined, divided, re-arranged, omitted, eliminated, and/or implemented in any other way. Further, the example external data communicator circuitry 205, the example panel creator circuitry 210, the example panel request circuitry 220, the example response matcher circuitry 240, the example weighting generator circuitry 250, the example correction factor calculator circuitry 260, the example correction factor application circuitry 270, and/or the example report outputter circuitry 280, more generally, the example server 152 of FIG. 2, may be implemented by hardware alone or by hardware in combination with software and/or firmware. Thus, for example, any of the example external data communicator circuitry 205, the example panel creator circuitry 210, the example panel request circuitry 220, the example response matcher circuitry 240, the example weighting generator circuitry 250, the example correction factor calculator circuitry 260, the example correction factor application circuitry 270, and/or the example report outputter circuitry 280, more generally, the example server 152, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example server 152 of FIG. 2 may include one or more elements, processes, and/or devices in addition to, or instead of, those illustrated in FIG. 2, and/or may include more than one of any or all of the illustrated elements, processes and devices.

A flowchart representative of example machine readable instructions, which may be executed to configure processor circuitry to implement the server 152 of FIG. 2, is shown in FIGS. 3 and/or 4. The machine readable instructions may be one or more executable programs or portion(s) of an executable program for execution by processor circuitry, such as the processor circuitry 512 shown in the example processor platform 500 discussed below in connection with FIG. 5 and/or the example processor circuitry discussed below in connection with FIGS. 6 and/or 7. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIGS. 3 and/or 4, many other methods of implementing the example server 152 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 3 and/or 4 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions and/or example operations that may be executed and/or instantiated by processor circuitry to match a predesignated sample with the external data 120 in order to obtain a correction factor to be applied to the panelist data. The machine readable instructions and/or the operations of the example non-response adjustment process 300 of FIG. 3 begin at block 310, at which the panel creator circuitry 210 identifies a predesignated sample for panel requests. (Block 310). As used herein, the predesignated sample refers to the sample of which it is desired to obtain response information for and may be any potential panelists (e.g., non-contacts 162, refusers 164, new panelists 166, and/or current panelists) from any period of time. The term predesignated sample includes all of the above-identified groups.

The panel creator circuitry 210 may employ a variety of methods for identifying the predesignated sample. For example, the panel creator circuitry 210 may employ a geographical based identifier in which the panel creator circuitry 210 uses geographical locations to determine who should be selected as a potential panelist. In doing so, the panel creator circuitry 210 determines the number of already existing panelists, if any, that are present in a geographical location. The panel creator circuitry 210 then determines where the observed geographical location needs greater representation and selects potential panelist(s) for a panel request.

Another example of a technique the panel creator circuitry 210 may employ to identify potential panelists for panel requests is a random sampling technique. This may include randomly selecting potential panelists. Determining, by comparing the randomly selected potential panelists to a list of current panelists, whether the potential panelist is already a current panelist. If the potential panelist is already a current panelist, the panel creator circuitry 210 disregards the potential panelist as an option. The panel creator circuitry 210 records the potential panelist as an option to be selected as a member of the panel. It should be known the panel creator circuitry 210 can employ other sampling techniques and/or variations of the ones described above to identify potential panelist for panel request. The panel creator circuitry 210 may use any combination of sampling techniques. It will be appreciated that if new sampling techniques are found, the panel creator circuitry 210 can be adapted for use thereof.

Following the identification of potential panelists for panel requests, the panel request circuitry 220 obtains the information from the panel creator circuitry 210 identifying the potential panelists. The panel request circuitry 220 then prompts potential panelists to join the panel. (Block 320). In some examples, recruitment of panelists may involve the installation of metering devices in the panelist household. In some examples, prompting the potential panelist may involve sending a panel questionnaire to the potential panelists. The questionnaire may have a multitude of questions for the potential panelist to answer, such as, for example, name, age, estimated time spent watching television, access to wireless, consent to be a panelist, etc. Of course, other approaches to requesting information from a potential panelist (or any other survey target) may additionally or alternatively be used including, for example, telephone calls, email messages, door-to-door contact, etc.

In some examples, blocks 310 and 320 may be skipped if the predesignated sample has already been identified, such as for example, the predesignated sample was a potential panel that was determined in the past, but consisted of non-contacts 162 and refusers 164 so no data was ever obtained.

Subsequently, after the panel request circuitry 220 sends out the questionnaire or engages in whatever recruitment process is chosen, potential panelists falls into the three distinct categories (e.g., non-contacts 162, refusers 164, and new panelists 166) described previously by the pie chart 160 shown in FIG. 1. The panel creator circuitry 210 sorts the potential panelists into the three distinct categories. (Block 330). In examples disclosed herein, the three distinct categories are new panelists 166 (e.g., potential panelists who respond to the request to join the panel), refusers 164 (e.g., potential panelists who refuse to join the panel), and non-contacts 162 (e.g., potential panelists who are not able to be contacted or do not respond).

Once the potential panelists have been sorted into non-contacts 162, refusers 164, and new panelists 166, the response matcher circuitry 240 matches the non-contacts 162 and refusers 164 with the external data 120 through the external communicator circuitry 205. (Block 340). The response matcher circuitry 240 creates a match by using the name and address of the non-contacts 162 and refusers 164. It should be known that in order to avoid privacy related issues with refusers 164, the response matcher circuitry 240 implements a double-blind match in which the viewers of the data are unable to identify the non-contacts 162 and refusers 164 by their name or address. But the viewers of the data are able to obtain the demographic information for the non-contacts 162 and refusers 164.

Upon a positive match being formed by the response matcher circuitry 240, the weighting generator circuitry 250 generates weighting information using the matched information from block 340. (Block 350). In some examples, the weighting information generated by the weighting generator circuitry 250 can include determining the weight of a potential panelist to account for missing or incomplete information. Further information regarding the execution of the weighting generator circuitry 250 is further described in reference to FIG. 4.

After the weighting scheme has been determined and the weighting information has been calculated by the weighting generator circuitry 250, the correction factor calculator circuitry 260 calculates a correction factor based on the weighting information. (Block 360). The correction factor is calculated by the correction factor calculator circuitry 260 utilizing predesignated formulas to correct and/or adjust for known systemic errors by taking into account deviations in the sample of panelists or the method used to measure the panelist data.

Once the correction factor is calculated, the correction factor application circuitry 270 applies the correction factor to the panel data. (Block 370). In some examples, further correction factors can be applied to adjust for lack of certain information not collected by the big data supplier that would have been collected by the meter had the household become a panelist through the normal recruitment process.

The example report outputter circuitry 280 generates a report of the panelist data with the correction factor applied. (Block 380). Such a report may be output in any format. For example, the report outputter circuitry 280 may generate a report in the form of a spreadsheet, document file, etc. The panelist data may further be output in any number of statistical representations, such as for example, a table or chart. The table or chart may include bar charts, line charts, pie charts, maps, density maps, scatter plots, or the like. The report outputter circuitry 280 may generate reports in physical form (e.g., print outs) or in digital formats. The report outputter circuitry 280 may also generate an output that is sent to storage and/or combined with other panelist data.

FIG. 4 is a flowchart representative of example machine readable instructions and/or example operations that may be executed and/or instantiated by processor circuitry to generate weighting information. The example generation of weighting information at block 350 begins at block 410, where the weighting generator circuitry 250 selects a potential panelist to which weighting is to be applied. In some examples, the potential panelist may be a non-contact 162 or a refuser 164. In some examples, the weighting generator circuitry 250 accesses the non-contacts 162 and refusers 164 from the external data 120 collected by the panel creator circuitry 210 (e.g., block 330 of FIG. 3). In other examples, the weighting generator circuitry 250 may access stored data housed on the example storage 154 within the audience measurement entity 150.

The weighting generator circuitry 250 then determines whether the potential panelist (selected at block 410) has already been weighted. (Block 420). In some examples, the potential panelist that has been identified was never contacted or refused, is already being used in another way by the audience measurement entity 150, and for some other purpose already has a weight.

When the weighting generator circuitry 250 determines that a weight has already been generated for the potential panelist (e.g., block 420 returns a result of YES), then the weighting generator circuitry 250 further determines whether the weight of the potential panelist should be regenerated. (Block 425). In some examples, the weight of the potential panelist, if the weight exists, may be inadequate for determining the importance of the potential panelist, and may thus affect the rest of the data collected. In one such example, the potential panelist may have already been asked to join the panel in a previous attempt but refused to join. When that potential panelist is asked again to join, the weighting generator circuitry 250 may indicate the potential panelist already has a weight. In asking the potential panelist to join again, the weight of the potential panelist may need to be adjusted due to the importance of the data that could be collected from the potential panelist.

When the weighting generator circuitry 250 determines that the weight for the potential panelist should be regenerated (e.g., block 425 returns a result of YES) or when the potential panelist does not have a weight (e.g., block 420 returns a result of NO), then the weight for the potential panelist is generated by the weighting generator circuitry 250. (Block 430). In some examples, when the potential panelist is reweighed, the potential panelist receives a different (e.g., higher) weight than it would have received if the data had come from the external data 120. In some examples, demographic and geographic information may also factor into determining the new weight of the potential panelist already including a weight.

When the weight has been generated for the potential panelist at block 430 or when the weighting generator circuitry 250 determines that the weight for the potential panelist does not need to be regenerated (e.g., block 425 returns a result of NO), then the weighting generator circuitry 250 compares the external data 120 to the panelist data collected during the recruitment process. (Block 440). In some examples, the external data 120 contains information not collected by the recruitment process because the potential panelist did not respond or refused to join the panel (e.g., non-contacts 162 or refusers 164). Examples of information that can be collected and compared against using the external data 120 include, but are not limited to, tuning differences, types of networks, specific networks, specific dayparts within specific networks, specific programs, demographic information, etc.

After comparing the external data 120 to the collected panelist data, the weighting generator circuitry 250 then determines whether secondary weighting factors should be applied to the potential panelist. (Block 450). In some examples, the secondary weighing factors are used to accurately represent the population of non-contacts 162 and refusers 164 from the number of potential panelists.

When the weighting generator circuitry 250 determines that secondary weighting factors should be applied (e.g., block 450 returns a result of YES), then the weighting generator circuitry 250 applies the secondary weighing factors to the potential panelist. (Block 455). In some examples, the secondary weighting factors may include a comparison of the data collected from the external data 120 and the data collected, and when applied, may give more or less weight to the potential panelist based on the comparison.

When the secondary weighting factors have been applied or when the weighting generator circuitry 250 determines that secondary weighting factors are not needed (e.g., block 450 returns a result of NO), then the weighting model is updated by the weighting generator circuitry 250 based on the information learned from generating the weight on the potential panelist. (Block 460). In some examples, the weighting generator circuitry 250 is adaptive to the influx of panelist data. As more panelist data is sent through the weighting generator circuitry 250, the weighting generator circuitry 250 adjusts the stratification for weighting to help create more accurate data. Over a set period of time or upon a sufficient detection of unexpected results, such as for example, a perturbed trend line, the weighting generator circuitry 250 makes improvements to the weighting model. The weighting adjustments have the effect of smoothing the trend line of the panelist data.

When the weighting model is updated at block 460, the weighting generator circuitry 250 then determines if any additional potential panelists remain. (Block 470). When the weighting generator circuitry 250 determines that additional potential panelists do remain (e.g., block 470 returns a result of YES), then blocks 410 through 470 are repeated until no additional potential panelists remain. When no additional potential panelists remain (e.g., block 470 returns a result of NO), then the example weighting generation process 400 ends.

FIG. 5 is a block diagram of an example processor platform 500 structured to execute and/or instantiate the machine readable instructions and/or the operations of FIGS. 3 and/or 4 to implement the server 152 of FIG. 2. The processor platform 500 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 500 of the illustrated example includes processor circuitry 512. The processor circuitry 512 of the illustrated example is hardware. For example, the processor circuitry 512 can be implemented by one or more integrated circuits, logic circuits, FPGAs, microprocessors, CPUs, GPUs, DSPs, and/or microcontrollers from any desired family or manufacturer. The processor circuitry 512 may be implemented by one or more semiconductor based (e.g., silicon based) devices. In this example, the processor circuitry 512 implements the example external data communicator circuitry 205, the example panel creator circuitry 210, the example panel request circuitry 220, the example response matcher circuitry 240, the example weighting generator circuitry 250, the example correction factor calculator circuitry 260, the example correction factor application circuitry 270 and the example report outputter circuitry 280.

The processor circuitry 512 of the illustrated example includes a local memory 513 (e.g., a cache, registers, etc.). The processor circuitry 512 of the illustrated example is in communication with a main memory including a volatile memory 514 and a non-volatile memory 516 by a bus 518. The volatile memory 514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 516 may be implemented by flash memory and/or any other desired type of memory device. Access to the main memory 514, 516 of the illustrated example is controlled by a memory controller 517.

The processor platform 500 of the illustrated example also includes interface circuitry 520. The interface circuitry 520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 522 are connected to the interface circuitry 520. The input device(s) 522 permit(s) a user to enter data and/or commands into the processor circuitry 512. The input device(s) 522 can be implemented by, for example, an audio sensor, a microphone, a camera (still or video), a keyboard, a button, a mouse, a touchscreen, a track-pad, a trackball, an isopoint device, and/or a voice recognition system.

One or more output devices 524 are also connected to the interface circuitry 520 of the illustrated example. The output device(s) 524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 520 of the illustrated example, thus, typically includes a graphics driver card, a graphics driver chip, and/or graphics processor circuitry such as a GPU.

The interface circuitry 520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 526. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 500 of the illustrated example also includes one or more mass storage devices 528 to store software and/or data. Examples of such mass storage devices 528 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 532, which may be implemented by the machine readable instructions of FIGS. 3 and/or 4, may be stored in the mass storage device 528, in the volatile memory 514, in the non-volatile memory 516, and/or on a removable non-transitory computer readable storage medium such as a CD or DVD.

FIG. 6 is a block diagram of an example implementation of the processor circuitry 512 of FIG. 5. In this example, the processor circuitry 512 of FIG. 5 is implemented by a microprocessor 600. For example, the microprocessor 600 may be a general purpose microprocessor (e.g., general purpose microprocessor circuitry). The microprocessor 600 executes some or all of the machine readable instructions of the flowchart of FIGS. 3 and/or 4 to effectively instantiate the server 152 as logic circuits to perform the operations corresponding to those machine readable instructions. In some such examples, the server 152 is instantiated by the hardware circuits of the microprocessor 600 in combination with the instructions. For example, the microprocessor 600 may be implemented by multi-core hardware circuitry such as a CPU, a DSP, a GPU, an XPU, etc. Although it may include any number of example cores 602 (e.g., 1 core), the microprocessor 600 of this example is a multi-core semiconductor device including N cores. The cores 602 of the microprocessor 600 may operate independently or may cooperate to execute machine readable instructions. For example, machine code corresponding to a firmware program, an embedded software program, or a software program may be executed by one of the cores 602 or may be executed by multiple ones of the cores 602 at the same or different times. In some examples, the machine code corresponding to the firmware program, the embedded software program, or the software program is split into threads and executed in parallel by two or more of the cores 602. The software program may correspond to a portion or all of the machine readable instructions and/or operations represented by the flowchart of FIGS. 3 and/or 4.

The cores 602 may communicate by a first example bus 604. In some examples, the first bus 604 may be implemented by a communication bus to effectuate communication associated with one(s) of the cores 602. For example, the first bus 604 may be implemented by at least one of an Inter-Integrated Circuit (I2C) bus, a Serial Peripheral Interface (SPI) bus, a PCI bus, or a PCIe bus. Additionally or alternatively, the first bus 604 may be implemented by any other type of computing or electrical bus. The cores 602 may obtain data, instructions, and/or signals from one or more external devices by example interface circuitry 606. The cores 602 may output data, instructions, and/or signals to the one or more external devices by the interface circuitry 606. Although the cores 602 of this example include example local memory 620 (e.g., Level 1 (L1) cache that may be split into an L1 data cache and an L1 instruction cache), the microprocessor 600 also includes example shared memory 610 that may be shared by the cores (e.g., Level 2 (L2 cache)) for high-speed access to data and/or instructions. Data and/or instructions may be transferred (e.g., shared) by writing to and/or reading from the shared memory 610. The local memory 620 of each of the cores 602 and the shared memory 610 may be part of a hierarchy of storage devices including multiple levels of cache memory and the main memory (e.g., the main memory 514, 516 of FIG. 5). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 602 may be referred to as a CPU, DSP, GPU, etc., or any other type of hardware circuitry. Each core 602 includes control unit circuitry 614, arithmetic and logic (AL) circuitry (sometimes referred to as an ALU) 616, a plurality of registers 618, the local memory 620, and a second example bus 622. Other structures may be present. For example, each core 602 may include vector unit circuitry, single instruction multiple data (SIMD) unit circuitry, load/store unit (LSU) circuitry, branch/jump unit circuitry, floating-point unit (FPU) circuitry, etc. The control unit circuitry 614 includes semiconductor-based circuits structured to control (e.g., coordinate) data movement within the corresponding core 602. The AL circuitry 616 includes semiconductor-based circuits structured to perform one or more mathematic and/or logic operations on the data within the corresponding core 602. The AL circuitry 616 of some examples performs integer based operations. In other examples, the AL circuitry 616 also performs floating point operations. In yet other examples, the AL circuitry 616 may include first AL circuitry that performs integer based operations and second AL circuitry that performs floating point operations. In some examples, the AL circuitry 616 may be referred to as an Arithmetic Logic Unit (ALU). The registers 618 are semiconductor-based structures to store data and/or instructions such as results of one or more of the operations performed by the AL circuitry 616 of the corresponding core 602. For example, the registers 618 may include vector register(s), SIMD register(s), general purpose register(s), flag register(s), segment register(s), machine specific register(s), instruction pointer register(s), control register(s), debug register(s), memory management register(s), machine check register(s), etc. The registers 618 may be arranged in a bank as shown in FIG. 6. Alternatively, the registers 618 may be organized in any other arrangement, format, or structure including distributed throughout the core 602 to shorten access time. The second bus 622 may be implemented by at least one of an I2C bus, a SPI bus, a PCI bus, or a PCIe bus

Each core 602 and/or, more generally, the microprocessor 600 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 600 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 7 is a block diagram of another example implementation of the processor circuitry 512 of FIG. 5. In this example, the processor circuitry 512 is implemented by FPGA circuitry 700. For example, the FPGA circuitry 700 may be implemented by an FPGA. The FPGA circuitry 700 can be used, for example, to perform operations that could otherwise be performed by the example microprocessor 600 of FIG. 6 executing corresponding machine readable instructions. However, once configured, the FPGA circuitry 700 instantiates the machine readable instructions in hardware and, thus, can often execute the operations faster than they could be performed by a general purpose microprocessor executing the corresponding software.

More specifically, in contrast to the microprocessor 600 of FIG. 6 described above (which is a general purpose device that may be programmed to execute some or all of the machine readable instructions represented by the flowcharts of FIGS. 3 and/or 4 but whose interconnections and logic circuitry are fixed once fabricated), the FPGA circuitry 700 of the example of FIG. 7 includes interconnections and logic circuitry that may be configured and/or interconnected in different ways after fabrication to instantiate, for example, some or all of the machine readable instructions represented by the flowcharts of FIGS. 3 and/or 4. In particular, the FPGA circuitry 700 may be thought of as an array of logic gates, interconnections, and switches. The switches can be programmed to change how the logic gates are interconnected by the interconnections, effectively forming one or more dedicated logic circuits (unless and until the FPGA circuitry 700 is reprogrammed). The configured logic circuits enable the logic gates to cooperate in different ways to perform different operations on data received by input circuitry. Those operations may correspond to some or all of the software represented by the flowcharts of FIGS. 3 and/or 4. As such, the FPGA circuitry 700 may be structured to effectively instantiate some or all of the machine readable instructions of the flowcharts of FIGS. 3 and/or 4 as dedicated logic circuits to perform the operations corresponding to those software instructions in a dedicated manner analogous to an ASIC. Therefore, the FPGA circuitry 700 may perform the operations corresponding to the some or all of the machine readable instructions of FIGS. 3 and/or 4 faster than the general purpose microprocessor can execute the same.

In the example of FIG. 7, the FPGA circuitry 700 is structured to be programmed (and/or reprogrammed one or more times) by an end user by a hardware description language (HDL) such as Verilog. The FPGA circuitry 700 of FIG. 7, includes example input/output (I/O) circuitry 702 to obtain and/or output data to/from example configuration circuitry 704 and/or external hardware 706. For example, the configuration circuitry 704 may be implemented by interface circuitry that may obtain machine readable instructions to configure the FPGA circuitry 700, or portion(s) thereof. In some such examples, the configuration circuitry 704 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 706 may be implemented by external hardware circuitry. For example, the external hardware 706 may be implemented by the microprocessor 600 of FIG. 6. The FPGA circuitry 700 also includes an array of example logic gate circuitry 708, a plurality of example configurable interconnections 710, and example storage circuitry 712. The logic gate circuitry 708 and the configurable interconnections 710 are configurable to instantiate one or more operations that may correspond to at least some of the machine readable instructions of FIGS. 3 and/or 4 and/or other desired operations. The logic gate circuitry 708 shown in FIG. 7 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 708 to enable configuration of the electrical structures and/or the logic gates to form circuits to perform desired operations. The logic gate circuitry 708 may include other electrical structures such as look-up tables (LUTs), registers (e.g., flip-flops or latches), multiplexers, etc.

The configurable interconnections 710 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 708 to program desired logic circuits.

The storage circuitry 712 of the illustrated example is structured to store result(s) of the one or more of the operations performed by corresponding logic gates. The storage circuitry 712 may be implemented by registers or the like. In the illustrated example, the storage circuitry 712 is distributed amongst the logic gate circuitry 708 to facilitate access and increase execution speed.

The example FPGA circuitry 700 of FIG. 7 also includes example Dedicated Operations Circuitry 714. In this example, the Dedicated Operations Circuitry 714 includes special purpose circuitry 716 that may be invoked to implement commonly used functions to avoid the need to program those functions in the field. Examples of such special purpose circuitry 716 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 700 may also include example general purpose programmable circuitry 718 such as an example CPU 720 and/or an example DSP 722. Other general purpose programmable circuitry 718 may additionally or alternatively be present such as a GPU, an XPU, etc., that can be programmed to perform other operations.

Although FIGS. 6 and 7 illustrate two example implementations of the processor circuitry 512 of FIG. 5, many other approaches are contemplated. For example, as mentioned above, modern FPGA circuitry may include an on-board CPU, such as one or more of the example CPU 720 of FIG. 7. Therefore, the processor circuitry 512 of FIG. 5 may additionally be implemented by combining the example microprocessor 600 of FIG. 6 and the example FPGA circuitry 700 of FIG. 7. In some such hybrid examples, a first portion of the machine readable instructions represented by the flowcharts of FIGS. 3 and/or 4 may be executed by one or more of the cores 602 of FIG. 6, a second portion of the machine readable instructions represented by the flowcharts of FIGS. 3 and/or 4 may be executed by the FPGA circuitry 700 of FIG. 7, and/or a third portion of the machine readable instructions represented by the flowcharts of FIGS. 3 and/or 4 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 512 of FIG. 5 may be in one or more packages. For example, the microprocessor 600 of FIG. 6 and/or the FPGA circuitry 700 of FIG. 7 may be in one or more packages. In some examples, an XPU may be implemented by the processor circuitry 512 of FIG. 5, which may be in one or more packages. For example, the XPU may include a CPU in one package, a DSP in another package, a GPU in yet another package, and an FPGA in still yet another package.

From the foregoing, it will be appreciated that example systems, methods, apparatus, and articles of manufacture have been disclosed that utilize third party, census level, data to continuously generate new weighting for application to future data. Disclosed systems, methods, apparatus, and articles of manufacture improve the efficiency of using a computing device by utilizing the continuously updating weighting scheme to create statistics and/or projections of a demographic population. As disclosed herein, the weighting values may be applied to panelist information to more accurately project and/or predict a total reach and/or audience of media. In this manner, such projections and/or predictions can be computed more efficiently, as compared to collecting census-level data from all potential media viewers. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to utilize third party, census level, data to continuously generate new weighting for application to future data are disclosed herein. Further examples and combinations thereof include the following:

Example 1 includes an apparatus to adjust panelist data comprising at least one memory, machine readable instructions, and processor circuitry to at least one of instantiate or execute the machine readable instructions to communicate with an external data source to obtain external data, the external data including information on a potential panelist, identify the potential panelist from the panelist data, generate weighting information on the potential panelist based on the panelist data using a weighting model, calculate a correction factor based on the weighting information, and apply the correction factor to update the panelist data.

Example 2 includes the apparatus of example 1, wherein the processor circuitry is further to cause display of a prompt to request the potential panelist to join a panel.

Example 3 includes the apparatus of example 2, wherein the processor circuitry is further to determine a category of the potential panelist representing a type of response to the request to join the panel.

Example 4 includes the apparatus of example 3, wherein the category represents at least one of non-responders, refusers, or new panelists.

Example 5 includes the apparatus of example 4, wherein the processor circuitry is further to match at least one of the non-responders or the refusers from the panelist data to the external data.

Example 6 includes the apparatus of example 1, wherein the processor circuitry is further to access data from a storage, wherein the data from the storage used to identify the potential panelist.

Example 7 includes the apparatus of example 1, wherein the processor circuitry is further to generate a report on the potential panelist based on the updated panelist data, wherein the potential panelist is representative of at least one of a non-responder or a refuser.

Example 8 includes the apparatus of example 1, wherein the processor circuitry is further to update the weighting model based on the weighting information.

Example 9 includes a method for adjusting panelist data comprising communicating with an external data source to obtain external data, the external data including information on a potential panelist, identifying the potential panelist from the panelist data, generating weighting information on the potential panelist based on the panelist data using a weighting model, calculating a correction factor based on the weighting information, and applying the correction factor to update the panelist data.

Example 10 includes the method of example 9, further including prompting to request the potential panelist to join a panel.

Example 11 includes the method of example 10, further including determining a category of the potential panelist representing a type of response to the request to join the panel, wherein the category representing at least one of non-responders, refusers, or new panelists.

Example 12 includes the method of example 11, further including matching at least one of the non-responders or the refusers from the panelist data to the external data.

Example 13 includes the method of example 9, further including accessing data from a storage, wherein the data from the storage used to identify the potential panelist.

Example 14 includes the method of example 9, further including outputting a report of the potential panelist based on the updated panelist data, wherein the potential panelist is representative of at least one of a non-responder or a refuser.

Example 15 includes the method of example 9, further including updating the weighting model based on the weighting information.

Example 16 includes an apparatus for adjusting panelist data comprising means for communicating with external data to obtain external data, the external data including information on a potential panelist, means for identifying the potential panelist from the panelist data, means for generating weighting information on the potential panelist based on the panelist data using a weighting model, means for calculating a correction factor based on the weighting information, and means for applying the correction factor to update the panel data.

Example 17 includes the apparatus of example 16, further including means for requesting the potential panelist to enter a panel.

Example 18 includes the apparatus of example 16, wherein the means for identifying further includes means for accessing data from the external data, and means for sorting the potential panelist into a category, wherein the category represents at least one of non-responders, refusers, or new panelists.

Example 19 includes the apparatus of example 18, further including means for matching at least one of the non-responders or the refusers from the panelist data with the external data.

Example 20 includes the apparatus of example 16, wherein the means for identifying further includes means for accessing data from a storage, wherein the data from the storage is used to identify the potential panelist.

Example 21 includes the apparatus of example 16, further including means for generating a report of the potential panelist based on the panelist data, wherein the potential panelist is representative of at least one of a non-responder or a refuser, and means for outputting the report.

Example 22 includes the apparatus of example 16, further including means for updating the weighting model based on the weighting information.

Example 23 includes a non-transitory machine readable storage medium comprising instructions that, when executed, cause processor circuitry to at least communicate with an external data source to obtain external data, the external data including information on a potential panelist, identify the potential panelist from the panelist data, generate weighting information on the potential panelist based on the panelist data using a weighting model, calculate a correction factor based on the weighting information, and apply the correction factor to update the panelist data.

Example 24 includes the non-transitory machine readable storage medium of example 23, wherein the instructions, when executed, further cause the processor circuitry to cause display of a prompt to request the potential panelist to join a panel.

Example 25 includes the non-transitory machine readable storage medium of example 24, wherein the instructions, when executed, further cause the processor circuitry to determine a category of the potential panelist representing a type of response to the request to join the panel, the category representing at least one of non-responders, refusers, or new panelists.

Example 26 includes the non-transitory machine readable storage medium of example 25, wherein the instructions, when executed, further cause the processor circuitry to match at least one of the non-responders or the refusers from the panelist data to the external data.

Example 27 includes the non-transitory machine readable storage medium of example 23, wherein the instructions, when executed, further cause the processor circuitry to access data from a storage, wherein the data from the storage used to identify the potential panelist.

Example 28 includes the non-transitory machine readable storage medium of example 23, wherein the instructions, when executed, further cause the processor circuitry to generate a report on the potential panelist based on the updated panelist data, wherein the potential panelist is representative of at least one of a non-responder or a refuser.

Example 29 includes the non-transitory machine readable storage medium of example 23, wherein the instructions, when executed, further cause the processor circuitry to update the weighting model based on the weighting information.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus to adjust panelist data comprising:
at least one memory;
machine readable instructions; and
processor circuitry to at least one of instantiate or execute the machine readable instructions to:
communicate with an external data source to obtain external data, the external data including information on a potential panelist;
identify the potential panelist from the panelist data;
generate weighting information on the potential panelist based on the panelist data using a weighting model;
calculate a correction factor based on the weighting information; and
apply the correction factor to update the panelist data.

2. The apparatus of claim 1, wherein the processor circuitry is further to cause display of a prompt to request the potential panelist to join a panel.

3. The apparatus of claim 2, wherein the processor circuitry is further to determine a category of the potential panelist representing a type of response to the request to join the panel.

4. The apparatus of claim 3, wherein the category represents at least one of non-responders, refusers, or new panelists.

5. The apparatus of claim 4, wherein the processor circuitry is further to match at least one of the non-responders or the refusers from the panelist data to the external data.

6. The apparatus of claim 1, wherein the processor circuitry is further to access data from a storage, wherein the data from the storage used to identify the potential panelist.

7. The apparatus of claim 1, wherein the processor circuitry is further to generate a report on the potential panelist based on the updated panelist data, wherein the potential panelist is representative of at least one of a non-responder or a refuser.

8. The apparatus of claim 1, wherein the processor circuitry is further to update the weighting model based on the weighting information.

9. A method for adjusting panelist data comprising:
communicating with an external data source to obtain external data, the external data including information on a potential panelist;
identifying the potential panelist from the panelist data;
generating weighting information on the potential panelist based on the panelist data using a weighting model;
calculating a correction factor based on the weighting information; and
applying the correction factor to update the panelist data.

10. The method of claim 9, further including prompting to request the potential panelist to join a panel.

11. The method of claim 10, further including determining a category of the potential panelist representing a type of response to the request to join the panel, wherein the category representing at least one of non-responders, refusers, or new panelists.

12. The method of claim 11, further including matching at least one of the non-responders or the refusers from the panelist data to the external data.

13. The method of claim 9, further including accessing data from a storage, wherein the data from the storage used to identify the potential panelist.

14. The method of claim 9, further including outputting a report of the potential panelist based on the updated panelist data, wherein the potential panelist is representative of at least one of a non-responder or a refuser.

15. The method of claim 9, further including updating the weighting model based on the weighting information.

16. An apparatus for adjusting panelist data comprising:
means for communicating with external data to obtain external data, the external data including information on a potential panelist;
means for identifying the potential panelist from the panelist data;
means for generating weighting information on the potential panelist based on the panelist data using a weighting model;
means for calculating a correction factor based on the weighting information; and
means for applying the correction factor to update the panel data.

17. The apparatus of claim 16, further including means for requesting the potential panelist to enter a panel.

18. The apparatus of claim 16, wherein the means for identifying further includes:
means for accessing data from the external data; and
means for sorting the potential panelist into a category, wherein the category represents at least one of non-responders, refusers, or new panelists.

19. The apparatus of claim 18, further including means for matching at least one of the non-responders or the refusers from the panelist data with the external data.

20. (canceled)

21. (canceled)

22. The apparatus of claim 16, further including means for updating the weighting model based on the weighting information.

23-29. (canceled)
